(19) United States
(12) Patent Application Publication
(10) Pub. No.: US 2013/0329558 A1
(43) Pub. Date: Dec. 12, 2013

(54) PHYSICAL LAYER BURST ABSORPTION

(71) Applicants: Nicholas Kucharewski, San Jose, CA (US); Martin Lund, Los Altos Hills, CA (US)

(72) Inventors: Nicholas Kucharewski, San Jose, CA (US); Martin Lund, Los Altos Hills, CA (US)

(73) Assignee: BROADCOM CORPORATION, Irvine, CA (US)

(21) Appl. No.: 13/490,896

(22) Filed: Jun. 7, 2012

(51) Int. Cl. H04L 12/24

(52) U.S. Cl. 370/235

(57) ABSTRACT

A system provides burst absorption of network traffic. The system may include multiple physical (PHY) layer devices in communication with a switch device. The switch device may instruct a PHY layer device to send incoming data received by the PHY layer device at a throttled rate, for example when the switch device identifies a high level of network congestion in the switch. The PHY layer device may absorb the burst of incoming network traffic by buffering incoming data in a queue and sending the incoming data to the queue at a throttled data transfer rate. When the network congestion has been alleviated, the PHY layer device may transmit network traffic to the switch at an accelerated transfer rate to empty the network traffic buffered in the queue.

### 1. TECHNICAL FIELD

This disclosure relates to physical (PHY) layer devices. This disclosure also relates to a PHY layer device for providing burst absorption of network traffic.

### 2. BACKGROUND

Rapid advances in electronics and communication technologies, driven by immense user demand, have resulted in vast interconnected networks of computing devices capable of exchanging immense amounts of data. Local Area Networks (LANs) may connect dozens or hundreds of computing devices in a single network. Perhaps the best known example of such interconnection of computing devices is the Internet or the World Wide Web, which continues to expand with each passing day. As technology continues to advance and interconnected computer networks grow in size and frequency of use, there is an increasing incentive to send and receive data more efficiently.

### BRIEF DESCRIPTION OF THE DRAWINGS

The innovation may be better understood with reference to the following drawings and description. In the figures, like reference numerals designate corresponding parts throughout the different views.

FIG. 1 shows an example of a system for providing burst absorption of network traffic.

FIG. 2 shows an example of a PHY device operating in a nominal transmission mode.

FIG. 3 shows an example of a PHY device operating in a throttled transmission mode.

FIG. 4 shows an example of a PHY device operating in an accelerated transmission mode

FIG. 5 shows an example of a system for providing burst absorption of network traffic.

FIG. 6 shows an exemplary state diagram that a PHY device may implement in hardware, software, or both.

### DETAILED DESCRIPTION

The discussion below makes reference to a PHY layer device. A PHY layer device may refer to a device that is implemented in the first layer (layer 1 or the physical layer) of the Open System Interconnection (OSI) model. Accordingly, the PHY layer device may be implemented without Media Control Access (MAC) logic. Logic implemented in the PHY layer device may be transparent to higher OSI level functionality of a network device and to external network devices as well. Other implementations of PHY layer devices are possible, however.

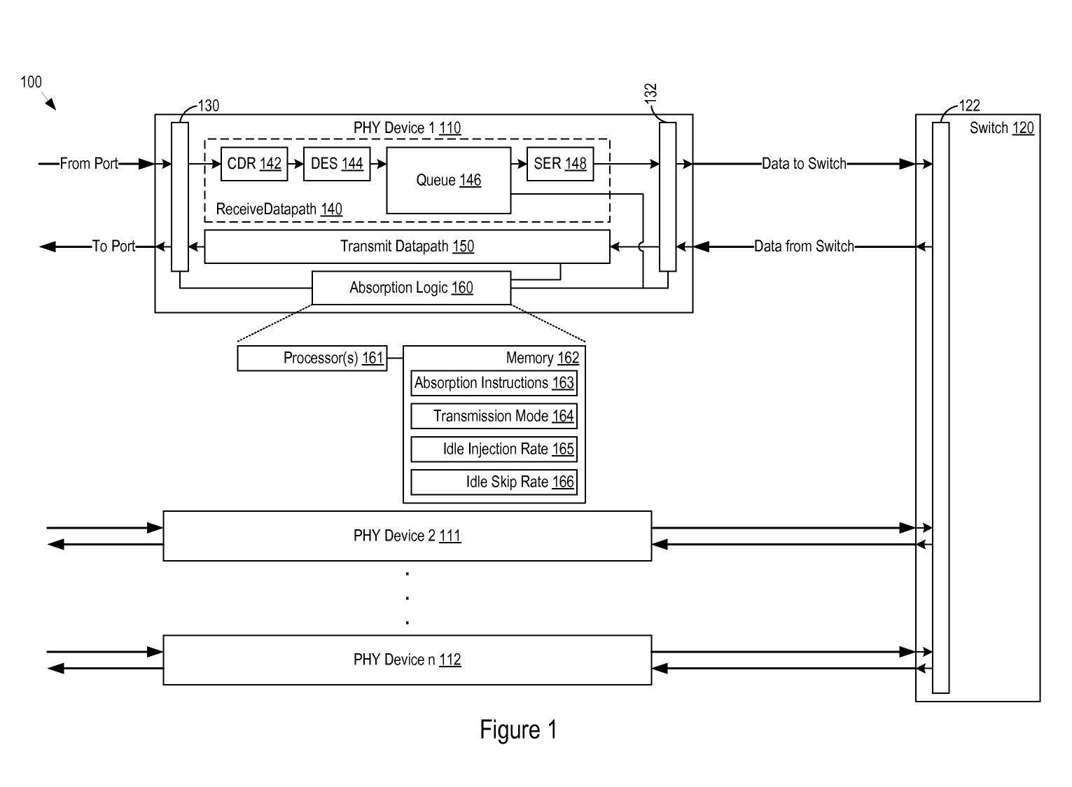

FIG. 1 shows an example of a system 100 for providing burst absorption of network traffic. The system 100 may include any number of PHY layer devices. As depicted in FIG. 1, the system 100 contains “n” number of PHY layer devices, three of which are labeled PHY Device 1 110, PHY Device 2 111, and PHY Device n 112. Each of the PHY layer devices are communicatively coupled to the switch 120. The switch 120 includes a PHY interface 122 through which the switch 120 may receive data and send data to each of the PHY layer devices, including PHY Device 1 110, PHY Device 2 111, and PHY Device n 112. The PHY layer devices 110-112 and the switch 120 may be implemented as part of a networking device capable of communicating data according to any number of communication protocols, for example Ethernet, Digital Subscriber Line (DSL), Integrated Services Digital Network (ISDN), Fiber Distributed Data Interface (FDDI), and other protocols.

PHY Device 1 110 includes a port interface 130. The port interface 130 may be communicatively coupled to a data port, such as an Ethernet port, a FireWire Port, a Universal Serial Bus (USB) port, or any other port configured to send or receive data, which the port may send or receive as a serial stream, or in other ways. The PHY Device 1 110 may receive incoming data from the data port and transmit outgoing data to the data port through the port interface 130. The PHY Device 1 110 also includes a switch interface 132 through which the PHY Device 1 110 can send data to the switch 120 and receive data from the switch 120.

PHY Device 1 110 further includes a receive datapath 140. PHY Device 1 110 may process incoming data received at the port interface 130 through the receive datapath 140 before sending the data to the switch 120. The receive datapath 140 may include any number of units, hardware, logic, or modules to allow PHY Device 1 110 to process incoming data received from a data port. In the example shown in FIG. 1, the receive datapath 140 includes a clock and data recovery (CDR) unit 142, a deserializer unit 144, a queue 146, and a serializer unit 148. The CDR unit 142 may be configured to recover a clock signal from data received serially without additional timing information, such as clock information.

The deserializer unit 144 and the serializer unit 148 may collectively form a “SerDes” unit that may encode or decode data according to a SerDes encoding technique. For example, the SerDes in the receive datapath 140 (e.g., the deserializer unit 144 and the serializer unit 148) may encode incoming data received from the data port according to an 8b/10b SerDes encoding technique or a 64b/66b SerDes encoding technique. To that end, the SerDes may produce a 10 bit symbol from 8 bits of incoming data according to an 8b/10b encoding technique or a 66 bit symbol from 64 bits of incoming data according to a 64b/66b encoding technique. In one implementation, PHY Layer Device 1 110 may encode the incoming data through the deserializer unit 144 prior to storing the data in the queue 146. Alternatively, PHY Layer Device 1 110 may encode the incoming data through the serializer unit 148 after retrieving data from the queue 146. The queue 146 may be implemented as a First-In-First-Out (FIFO) queue.

PHY Device 1 110 also includes a transmit datapath 150 that may include any number of units, hardware, logic, or modules to allow PHY Device 1 110 to process outgoing data received from the switch 120 before transmitting the outgoing data to a data port. For example, the switch 120 may communicate outgoing data to PHY Device 1 110 as 10 bit or 66 bit symbols encoded according to an 8b/10b or 64b/66b SerDes encoding technique. The transmit datapath 150 may also include a SerDes unit to transform the received 10 bit or 66 bit symbols into corresponding 8 bit or 64 bit outgoing data.

PHY Device 1 110 shown in FIG. 1 includes absorption logic 160. In one implementation, the absorption logic 160 includes one or more processors 161 and a memory 162. The memory 162 stores, for example, absorption instructions 163 that the processor 161 executes. The memory 162 also stores absorption parameters, such as a transmission mode parameter 164, an idle injection rate parameter 165, and an idle skip rate parameter 166. As will be described in more detailed below, the absorption instructions 163, the transmission mode parameter 164, the idle injection rate parameter 164, and the idle skip rate parameter 166 may control transfer of incoming network data to the switch 120 according to various transmission modes a PHY layer device may operate in.

In operation, the system 100 may provide burst absorption of network traffic in the switch 120 through packet buffering in PHY layer devices, such as PHY Device 1 110. For example, the switch 120 may identify high levels of network traffic congestion, such as when an ingress queue of the switch 120 reaches capacity or surpasses a high congestion threshold. The absorption logic 160 may buffer incoming data received by PHY Device 1 110 in the queue 146 and transmit the data to the switch 120 at a reduced rate, as discussed in greater detail below. Thus, the data accumulation rate of the switch ingress queue may be reduced due to PHY Device 1 110 sending the incoming data to the switch 120 at a reduced rate. The switch 120 may then be able to process network data in the ingress queue at a rate faster than the data accumulation rate in the ingress queue. Thus, the switch 120 may lessen the amount of data stored in the ingress queue and alleviate the high level of network traffic congestion. When the high congestion level of network traffic in the switch 146 has passed, PHY Device 1 110 may transmit data to the switch 120 at an accelerated rate in order to empty accumulated network data buffered in the queue 146 of PHY Device 1 110.

The absorption logic 160 may throttle the rate at which bits of data are transferred (transfer rate) to the switch 120. As one example, the absorption logic 160 may slow the clock frequency of portions of the PHY device 1 110, including, for example, the serializer 148 and the switch interface 132. In this way, the earlier portions of the receive datapath 140, e.g., the port interface 130, the CDR unit 142 and the deserializer unit 144, may process incoming data at the initial or normal rate while later portions of the datapath, e.g., the serializer unit 148 and the switch interface 132, process the incoming data at reduced rate. The difference in processing speed may cause incoming data to accumulate in the queue 146. Similarly, PHY Device 1 110 may transfer bits of data to the switch 120 at an accelerated transfer rate by increasing the clock frequency of the later portions of the receive datapath 140, thereby emptying contents of the queue 146.

Alternatively, PHY Device 1 110 may transmit the incoming data to the switch 120 at a reduced rate without changing clock frequency and without affecting the content of the incoming data. In the example shown in FIG. 1, the absorption logic 160 may cause the PHY Device 1 110 to operate according to a nominal transmission mode, a throttled transmission mode, or an accelerated transmission mode. PHY Device 1 110 may transmit data to the switch 120 at a constant data transfer rate and operate in a constant clock frequency whether operating in the nominal transmission mode, the throttled transmission mode, or the accelerated transmission mode. In order to throttle transmission of the incoming data, the absorption logic 160 may transmit pacing data to the switch 120 that does not change or alter the content of the incoming data. The pacing data may take many different forms, including a NULL, NOP, or idle character, symbol, words, or packet according to any communication protocol, or any combination thereof. The absorption logic 160 may insert pacing data into the data transmitted to the switch 120.

In a similar fashion, PHY Device 1 110 may transmit data to the switch 120 at an accelerated rate without changing clock frequency of any portion of the receive datapath 140. For example, and as discussed below, the absorption logic 160 may skip or forego transmission of selected data, such as an idle character, word, or symbol, in the received incoming data. In this manner, PHY Device 1 110 may forward the incoming data to the switch 120 at an accelerated rate without changing clock frequency and without affecting the meaningful content of the incoming data, such as the non-idle content of the incoming data.

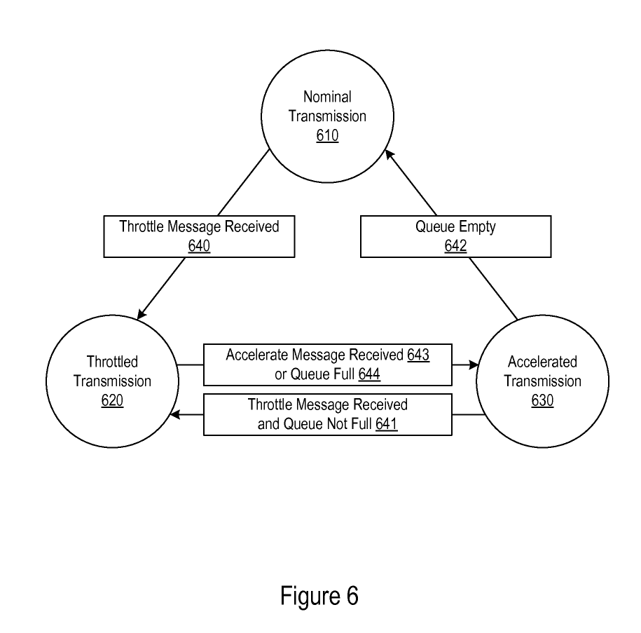

PHY Device 1 110 may operate in multiple transmission modes depending on the network traffic congestion level of the switch 120. The absorption logic 160 may track the current transmission mode in which the PHY Device 1 110 is operating. For example, the absorption logic 160 may store the current transmission mode as the transmission mode parameter 164. The transmission mode parameter 164 may be a value that the absorption logic 160 stores in a register or other memory space. In one implementation, PHY Device 1 110 may operate in a nominal transmission mode, a throttled transmission mode, and an accelerated transmission mode. PHY Device 1 110 may transition between transmission modes by changing the value of the transmission mode parameter 164 under various circumstances or in response to a transition condition. For example, the absorption logic 160 may change the transmission mode upon receiving a flow control message from the switch 120 or based on the amount of data in the queue 146. Transition between transmission modes is detailed in FIG. 6 and discussed with greater specificity below.

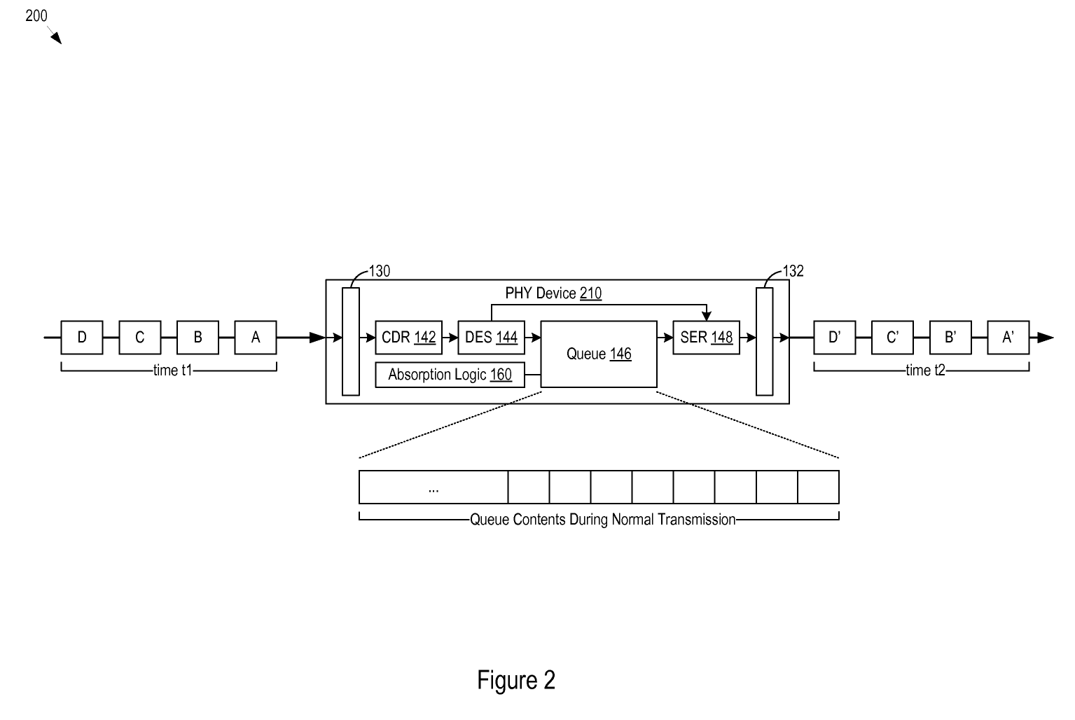

FIG. 2 shows an example 200 of a PHY device 210 operating in a nominal transmission mode. The PHY device 210 may be configured similarly to PHY Device 1 110 as described in FIG. 1. As with PHY Device 1 110, the PHY device 210 shown in FIG. 2 includes a port interface 130, a switch interface 132, a CDR unit 142, a deserializer unit 144, a queue 146, a serializer 148, and absorption logic 160. When operating in a nominal transmission mode, the PHY Device 210 may communicate processed incoming network data through the switch interface 132 at an outgoing transfer rate equal to an incoming rate at which the incoming data is received from the port interface 130. Or, the PHY Device 210 may communicate processed incoming network data to the switch at a rate normally expected by the switch 120. The transfer rate of data to the switch 120 when the PHY Device 210 operates according to a nominal transmission mode may be referred to as the nominal transfer rate. When operating in nominal transmission mode and sending data to the switch 120 at the nominal transfer rate, the amount of data in the queue 146 may not increase or decrease. However, the content of data in the queue 146, if any, may change as the receive datapath 140 receives, processes, and sends incoming data to the switch 120.

In one implementation, the PHY device 210 operates in a nominal transmission mode when the queue 146 is empty. The queue 146 may remain empty during nominal transmission mode because processed incoming data is transmitted to the switch 120 at the same rate incoming data is received from the data port, e.g., at the nominal transfer rate. Thus, as seen in FIG. 2, no incoming data will accumulate in the queue 146 when the PHY device 210 operates in nominal transmission mode. For example, as seen in FIG. 2, data words A, B, C, and D may be in the process of being transmitted to the PHY device 210 at a time t1. At a later time t2, the PHY device 210 operating in a nominal transmission mode may have processed the data words and transmitted processed data A′, B′, C′, and D′ to the switch 210. At these times, the contents of the queue 146 remain empty.

During nominal transmission mode, incoming data deserialized by the deserializer unit 144 may momentarily pass through the queue 146 upon which the data may be encoded and serialized by the serializer 148. Alternatively, the absorption logic 160 may instruct the PHY device 210 to bypass use of the queue 146 during nominal transmission mode. In the example shown in FIG. 2, the deserializer unit 144 may be coupled to the serializer 148 through a direct a communication path, thereby bypassing the queue 146. The absorption logic 160 may instruct the deserializer unit 144 to the send deserialized incoming data through the direct communication path to the serializer unit 148 instead of to the queue 146.

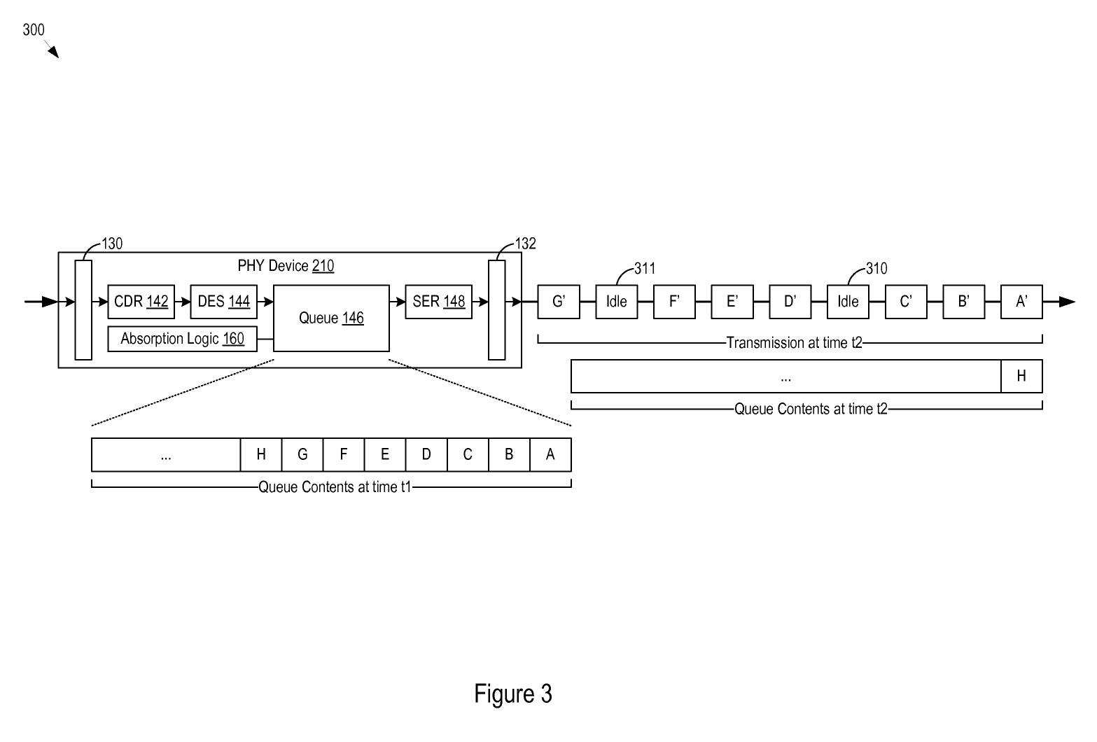

FIG. 3 shows an example 300 of a PHY device 210 operating in a throttled transmission mode. The absorption logic 160 may cause the PHY device 210 to transmit incoming data received by the port interface 130 at a transfer rate slower than the nominal transfer rate discussed in FIG. 2. To that end, the absorption logic 160 may periodically transmit pacing data to the switch 120 when operating in a throttled transmission mode. The switch 120 may recognize and disregard the pacing data instead of adding the pacing data to an ingress queue of the switch 120. In one example, the pacing data may be data that the switch 120 recognizes as an idle character or word, such as the 8-bit value for ASCII synchronous idle 00010110 or the corresponding encoded 10-bit SerDes symbol. Alternatively, the pacing data may be any idle, NULL, or NOP word implemented by any communication protocol, such as an idle word used by a communication protocol to indicate a gap between incoming packets.

The absorption logic 160 may periodically transmit pacing data (e.g., an idle word) instead of the next word of data in the queue 146. In one implementation, the absorption logic 160 may periodically forego reading the next word from the queue 146 and transmit an idle word to the serializer unit 148 instead. Thus, the absorption logic 160 may throttle the transfer rate at which the incoming data received from the port interface 130 is transmitted to the switch 120, without changing the net rate at which data is delivered to the switch 120. As the PHY device 210 operates in a throttled transmission mode and the absorption logic 160 interleaves pacing data into the data stream transmitted to the switch 120, the amount of data stored in the queue 146, or queued data, may increase. That is, each time the absorption logic 160 inserts pacing data into the data stream instead of the next data word of the incoming data, an additional word may accumulate in the queue 146. The contents queued data may change as the PHY Device 210 receives, processes, and transmits incoming data to the switch 120. However, the longer the PHY Device 210 operates in a throttled transmission mode, the greater the amount of queued data, e.g., buffered network traffic, that may be stored in the queue 146. Any amount of queued data may reflect that a PHY layer device has previously operated or is currently operating in a throttled transmission mode. For example, as seen in FIG. 2, the queue 146 stores at least the data words A, B, C, D, E, F, G, and H at a time t1 (queued data at time t1). This queued data may indicate that the PHY layer Device 210 was previously or is currently operating in a throttled transmission mode.

The absorption logic 160 may interleave pacing data, e.g., an idle word, character, or symbol, into the data stream at a rate or period specified by the idle injection rate parameter 165. The idle injection rate parameter 165 may be stored as a register value in the memory 162 and may be implemented as a numerical value. The absorption logic 160 may insert pacing data (e.g., an idle word) after reading a number of words from the queue 146, the number specified by the idle injection rate parameter 165. For example, the idle injection rate parameter 165 may have a value of 3. That is, after reading three words from the queue 146, the absorption logic 160 may insert an idle word into the data stream instead of reading the next word from the queue 146. As seen in FIG. 3, the data stream transmitted from the PHY device 210 at a time t2 may include processed data words A′, B′, C′, injected idle word 310, D′, E′, F′, injected idle world 311 and G′. As seen, the absorption logic 160 added injected idle word 310 and injected idle word 311 to the data stream at an idle injection rate of 3 words. At a time t2, the contents of the queue 146 may include data word H. The contents of the queue 146 at time t2 may also include additional data that may have accumulated as a result of the PHY device 210 operating in a throttled transmission mode.

As one implementation example, the absorption logic 160 may configure an idle injection counter that increments each time a word is read from the queue 146. When the idle injection counter is equal to the value of the idle injection rate parameter 165, the absorption logic 160 may reset the counter and insert an idle word into the data stream instead of reading the next word in the queue 146. Alternatively, the absorption logic 160 may configure the idle injection counter to start at a value equal to the idle injection rate parameter 165 and decrement each time a word is read from the queue 146. When the idle injection counter reaches a value of zero, the absorption logic 160 may then insert an idle word and reset the idle injection counter to the idle injection rate parameter 165.

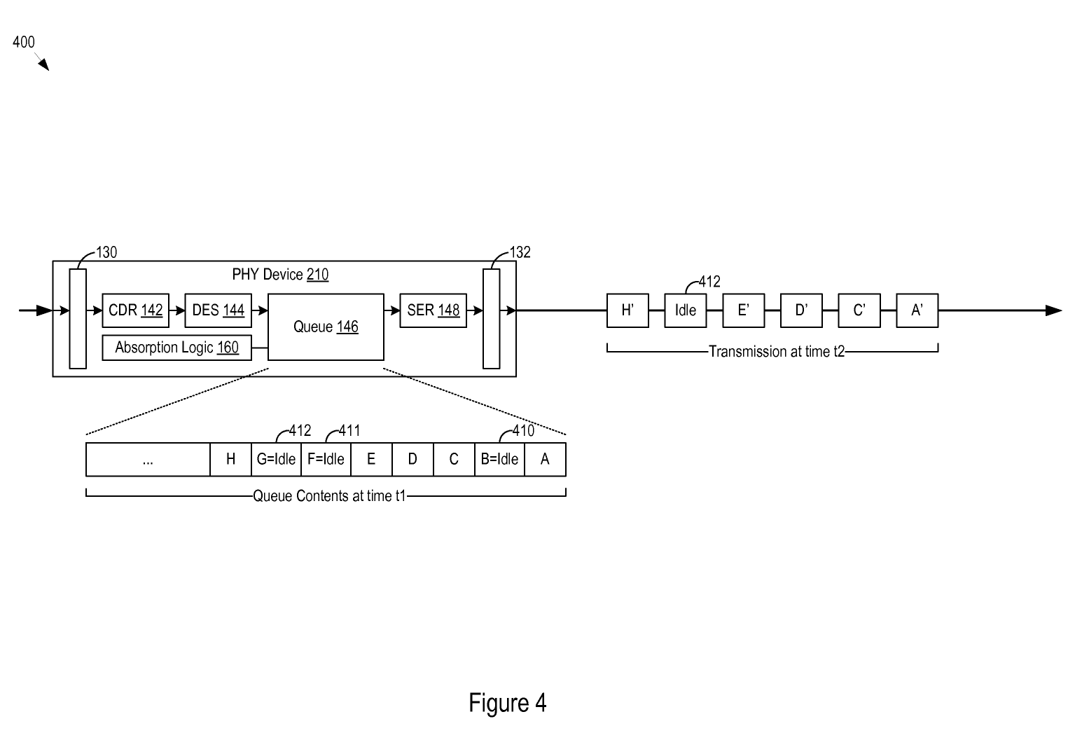

FIG. 4 shows an example 400 of a PHY device 210 operating in an accelerated transmission mode. The PHY device 210 may operate in an accelerated transmission mode to decrease the amount of data accumulated in the queue 146 when the PHY device 210 previously operated in a throttled transmission mode. When operating in an accelerated transmission mode, the absorption logic 160 may cause the PHY device 210 to transmit incoming data received by the port interface 130 at a transfer rate faster than the nominal transfer rate discussed in FIG. 2.

The absorption logic 160 may transmit queued data (e.g., data stored in the queue 146) to the switch 120 at an accelerated transfer rate by omitting transmission of unselected data from the queued data. The absorption logic 160 may skip transmission of an unselected data word and instead transmit the next data word of the incoming data. Unselected data may be any data that the absorption logic 160 omits from the data stream for transmission to the switch 120. Unselected data may be incoming data or queued data that the absorption logic 160 omits and may take any number of forms. In one example, unselected data may be similar to the pacing data inserted by the absorption logic 160 when the PHY device 210 operates in a throttled transmission mode, such as extra data that does not affect the substantive content of the incoming data stream. For example, the unselected data may be idle, NULL, or NOP words, symbols, characters, or packets implemented by any communication protocol, such as an idle word used to indicate a gap between packets of the incoming data. The absorption logic 160 may also identify unselected data from any subset, pattern, sequence, or progression of potential unselected data. For example, the absorption logic 160 may identify potential unselected data as any idle, NULL, or NOP word, symbol, character, or packet implemented by any communication protocol, or any combination thereof. The absorption logic 160 may identify a subset of potential unselected data as unselected data to omit from transmission to the switch 120.

In the example shown in FIG. 4, the absorption logic 160 may identify an idle word as unselected data. The absorption logic 160 may read queued data, such as a data word from the queue 146, and identify if the read data word is a potential unselected data word, e.g., an idle word. If so, the absorption logic 160 omits transmission of the idle word by disregarding the idle word and instead transmitting the next data word in the queue 146. For example, the absorption logic 160 may drop the unselected data word, e.g., idle word, from the data stream transmitted to the switch 130. Phrased alternatively, the absorption logic 160 may drop the identified idle word from the data stream and instead read the next data word in the queue 146 to send to the serializer unit 148. Thus, the absorption logic 160 may accelerate the transfer rate at which selected content of the incoming data received from the port interface 130 is transmitted to the switch 120. The selected content may include all queued data is that is not omitted by the absorption logic 160—that is, selected queued may be the remaining data from the incoming stream that is not omitted as unselected data. As discussed in greater detail below, the selected content sent to the switch 120 may include potential unselected data that was not omitted from the data stream.

As the PHY device 210 operates in an accelerated transmission mode and the absorption logic 160 foregoes transmission of unselected data in the data stream transmitted to the switch 120, the amount of data queued data may decrease. For example, each time the absorption logic 160 omits transmission of unselected data, such as an idle word, and transmits the next data word instead, an additional word is removed from the queue 146. Content of the queue 146 may change as the PHY device 210 receives, processes, and transmits incoming data to the switch 120. However, the longer the PHY Device 210 operates in an accelerated transmission mode, the less the amount of queued data, e.g., buffered network traffic, that may be stored in the queue 146.

In the example shown in FIG. 4, the absorption logic 160 may classify potential unselected data as idle words. The queue 146 may contain buffered data A, B, C, D, E, F, and G at a time t1. Data word B 410, data word F 411, and data word G 412 may each be potential unselected data, e.g., an idle word, as depicted in FIG. 4. When processing the buffered network data, the absorption logic 460 may identify that data word B 410 as unselected data. Thus, the absorption logic 460 may skip transmission of data word B 410, and instead read data word C from the queue 146 and send data word C to the serializer unit 148. As seen in FIG. 4, the data transmitted from the switch interface 132 at a time t2 does not include data word B 410 as the absorption logic 160 omitted data word B 410 from the data stream.

The absorption logic 160 may omit unselected data (e.g., an identified idle word) and read the next data word from the queue 146 within a single clock cycle. That is, the absorption logic 160 may identify if the first data word read from the queue 146 in a clock cycle is potential unselected data and omit the identified potential unselected data from the data stream, whereupon the potential unselected data becomes unselected data. The absorption logic 160 may read and send the next data word in the queue 146. The identification of potential unselected data, omitting of the unselected data, reading of the next queued data word, and sending of the next queued data word may occur within a single clock cycle. In FIG. 4, after identifying the first read data word as unselected data, the absorption logic 160 reads and sends the next data word in the queue 146 regardless of the content of the next data word. Thus, when the absorption logic 160 identifies data word F 411 as unselected data, the absorption logic 160 may omit transmission of data word F 411 to the switch 120 by dropping data word F 411 from the data stream. Instead, the absorption logic 160 reads and sends the next data word from the queue 146—that is, data word G41, regardless of the content of data word G 412. Thus, the absorption logic 160 may send data word G 412 for transmission to the switch 120 even though data word G 412 is potential unselected data. As seen in FIG. 4, the data transmitted from the switch interface 132 at a time t2 includes data word G 412, even though data word G 412 is an idle word.

In alternative implementations, the absorption logic 160 may skip transmission of the first data word and the second data word if both are identified as unselected data within a clock cycle, and instead transmit the third data word read from the queue 146. Similarly, the absorption logic 160 may skip any number of consecutively identified unselected data (e.g., idle words) from the queue 146, which may be limited by the amount of unselected data (e.g., number of idle words) the absorption logic 160 can identify within a single clock cycle.

In the example shown in FIG. 4, the absorption logic 160 skipped transmission of an idle word each time the idle word was the first data word read from the queue 146 in a clock cycle. Alternatively, the absorption logic 160 may omit transmission of unselected data at a rate or period specified by the idle skip rate parameter 166. The idle skip rate parameter 166 may be stored as a register value in the memory 162 and may be implemented as a numerical value. The absorption logic 160 may omit transmission of unselected data after identifying an amount of potential unselected data from the queue 146, the number specified by the idle skip rate parameter 166. In one implementation, the absorption logic 160 may apply the idle skip rate parameter 166 to potential unselected data identified from the first data word read from the queue 146 in a clock cycle. Alternatively, the absorption logic 160 may apply the idle skip rate parameter 166 to all potential unselected data identified in the data stream.

For example, the idle skip rate parameter 166 may have a value of 8. In one implementation, after identifying 8 potential unselected data words (e.g., idle words) read from the queue 146, the absorption logic 160 may identify the next potential unselected data word (e.g., idle word) as unselected data. That is, the absorption logic 160 may omit the next identified potential unselected data (e.g., idle word) from the data stream to the switch 120. Instead, the absorption logic 160 may read the next word from the queue 146. The absorption logic 160 may configure the idle skip rate parameter 166 to prevent the PHY Device 210 from emptying data buffered in the queue 146 too quickly, which may overwhelm the switch 120.

As one implementation example, the absorption logic 160 may configure an idle skip counter that increments each time the first data word read from the queue 146 is identified as potential unselected data. When the idle skip counter reaches a value equal to the idle skip rate parameter 166, the absorption logic 160 may omit transmission of the next identified potential unselected data word, thereby identifying this next potential unselected data as unselected data. The absorption logic 160 may then read the next queued data word to process. Alternatively, the absorption logic 160 may configure the idle skip counter in a reverse manner, decrementing to zero before skipping transmission of an unselected data word.

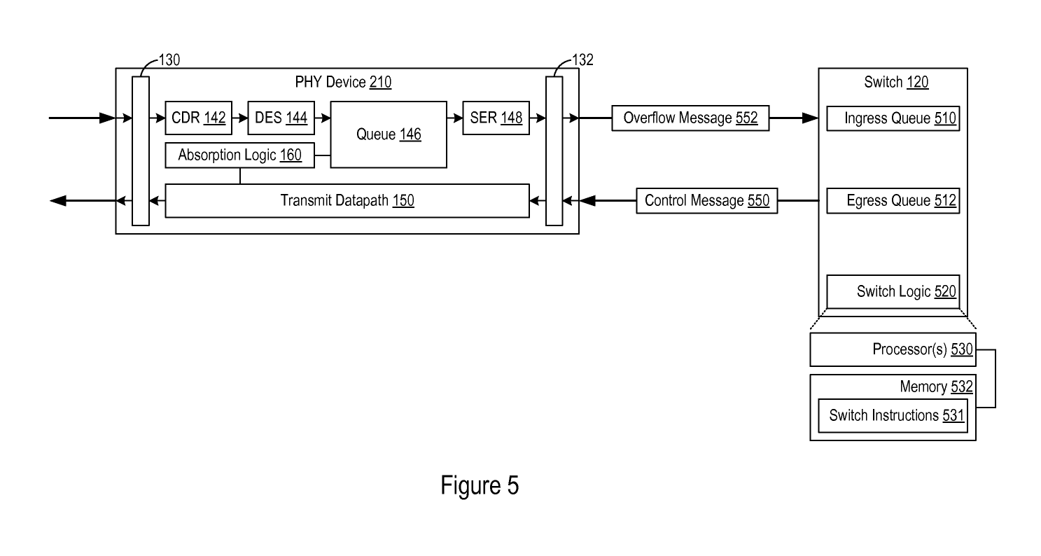

FIG. 5 shows an example of a system 500 for providing burst absorption of network traffic. The system 500 includes the PHY device 210 and the switch 120. In the example shown in FIG. 5, the switch 120 includes an ingress queue 510, an egress queue 512, and switch logic 520, that may be implemented as one or more processors 530 and a memory 532. The memory 532 stores, for example, switch instructions that when executed by the processor 530, control flow of network traffic to the switch 120. For example, the switch logic 520 may determine conditions to transmit a flow control message to the PHY device 210, such as the control message 550. The flow control message, such as the control message 550, may include information or instructions to control the transmission mode the PHY device 210 operates in. The switch logic 520 may transmit a flow control message to the PHY device 210 by, for example, adding the control message 550 to an egress queue 512 that buffers data for transmission to the PHY device 210.

The switch logic 520 may transmit a flow control message to the PHY device 210 when the switch logic 520 identifies a high congestion condition. The high congestion condition may be determined based on network traffic level in the switch 120, for example when the amount of data in the ingress 510 exceeds a high congestion threshold parameter. The switch logic 520 may configure the high congestion threshold parameter to be a numerical value stored as a register value in the memory 530. As one example, the switch logic 520 may configure the high congestion threshold parameter to be 80% of the capacity of the ingress queue 510. In this example, when switch logic 520 identifies the amount of data in the ingress queue 510 has exceeded 80% of the capacity of the ingress queue 510, the switch logic 520 may send the control message 550 to the PHY device 210. For instance, the switch logic 520 may send a throttle message to the PHY device 210 instructing the PHY device 210 to reduce the transfer rate of incoming data to the switch 120. The PHY device 210 may receive the throttle message and the absorption logic 160 may transition operation of the PHY device 210 to a throttled transmission mode and insert pacing data into the data stream transmitted to the switch 120. In one implementation, the switch logic 520 can disregard or drop the pacing data, such as an idle word, received from the PHY device 210 instead of adding the pacing data to the ingress queue 510 for processing.

The switch logic 520 may also transmit a flow control message, such as the control message 550, to the PHY device 210 when the switch logic 520 identifies that a high congestion condition has been relieved. For instance, the switch logic 520 may identify that a congestion condition has been relieved when the amount of data in the ingress queue 510 drops below the high congestion threshold parameter discussed above. The switch logic 520 may then send a control message 550 to the PHY device 210 instructing the PHY device 210 to accelerate the transfer rate of incoming data to switch 210.

Alternatively, the switch logic 520 may transmit a control message 550 to the PHY device 210 when the switch logic 520 identifies a low congestion condition. The low congestion condition may be determined based on network traffic level in the switch 120, for example when the amount of data in the ingress 510 drops below a low congestion threshold parameter. The switch logic 520 may configure the low congestion threshold parameter to be a numerical value stored as a register value in the memory 530. As one example, the switch logic 520 may configure the low congestion threshold parameter to be 50% of the capacity of the ingress queue 510. In this example, when switch logic 520 identifies the amount of data in the ingress queue 510 has dropped below 50% of the capacity of the ingress queue 510, the switch logic 520 may send a control message 550 to the PHY device 210. For instance, the switch logic 520 may transmit an accelerate message to the PHY device 210 instructing the PHY device 210 to accelerate the transfer rate of incoming data to the switch 120.

The PHY device 210 may receive a control message 550 from the switch 120 in the switch interface 132. The switch interface 132 may then pass the control message 550 through the transmit datapath 150. The absorption logic 160 may identify the control word 550 in the transmit datapath 150, for example by inspecting encoded deserialized words in the transmit datapath 150. Upon identifying a control message 552, the absorption logic 160 may respond based on information or instructions identified from the control word 550, for example to transition the transmission mode the PHY device 210 operates in.

In one implementation, the absorption logic 160 of the PHY device 210 may communicate a control message to the switch 120. For instance, the absorption logic 160 may send an overflow message 552 to the switch 120 when the absorption logic 160 identifies an overflow condition. The absorption logic may identify an overflow condition when the amount of data in the queue 146 exceeds an overflow threshold parameter. The absorption logic 160 may configure the overflow threshold parameter to be a numerical value stored as a register value in the memory 162. As one example, the absorption logic 160 may configure the overflow threshold parameter to be 95% of the capacity of the queue 146. In this example, when absorption logic 160 identifies the amount of data in the queue 146 has exceeded 95% of the capacity of the queue 146, the absorption logic 160 may send an overflow message 552 to the switch 120. The absorption logic 160 may also transition operation of the PHY device 210 to an accelerated transmission mode to lessen the amount of data in the queue 146 or a nominal transmission mode to prevent data loss or ensure the amount of data in the queue 146 does not overflow.

In response to receiving an overflow message 552 from the PHY device 210, the switch logic 520 may use flow control methods specified by a communication protocol to stem network congestion levels in the switch 120. For example, the switch logic 520 may send an Ethernet PAUSE frame directed to external devices transmitting data to the switch 120. In another implementation, the switch logic 520 may not take any action in response to receiving the overflow message 552 from the PHY device 210, which may result in overflow of the ingress queue 510 and packet loss in the switch 120.

The PHY device 210 and the switch 120 may exchange flow control messages, such as the control message 550 and the overflow message 552, in any number of ways. In the example shown in FIG. 5, the PHY device 210 and the switch 120 may exchange control messages through the same communication channel through which the PHY device 210 and the switch 120 communicate incoming data received from a data port and outgoing data for transmission through the data port. For example, the PHY device 210 and the switch 120 may communicate incoming and outgoing data in the Physical Coding Sublayer (PCS) using an 8b/10b SerDes encoding technique or a 64b/66b SerDes encoding technique. Both the 8b/10b SerDes encoding technique and the 64b/66b SerDes encoding technique may include respective 10 bit and 66 bit reserved symbols that the absorption logic 160 and the switch logic 520 may assign as the overflow message 552 or a control message 550. In this way, the PHY device 210 and the switch 120 may communicate control messages using the pre-existing PCS SerDes communication link, thus minimizing additional logic or overhead to send and receive a flow control message. In an alternative embodiment, the PHY device 210 and the switch 120 may send and receive a flow control message via a dedicated communication link or dedicated channel established between the PHY device 210 and the switch 120, for example through a switch interface 132 and a PHY interface 122.

FIG. 6 shows an exemplary state diagram 600 that a PHY device 210 may implement in hardware, software, or both. For example, the PHY device 210 may implement the state diagram 600 as the absorption logic 160. The state diagram 600 depicts circumstances where the PHY device 210 may transition between operating according to various transmission modes in response to transition conditions. The state diagram 600 shown in FIG. 6 includes a nominal transmission mode 610, a throttled transmission mode 620, and an accelerated transmission mode 630. In one implementation, the absorption logic 160 may transition the PHY device 210 between transmission modes by altering the value of the transmission mode parameter 164 stored in the memory 162.

The absorption logic 160 may transition operation of the PHY device 210 from the nominal transmission mode 610 to the throttled transmission mode 620 in response, for example, to the transition condition 640 of receiving a throttle message from the switch 120. The absorption logic 160 may transition operation of the PHY device 210 from the accelerated transmission mode 630 to the throttled transmission mode 610 in response, for instance, to the transition condition 641 when the absorption logic 160 receives a throttle message and when the queue 146 has not exceeded an overflow threshold parameter.

The absorption logic 160 may also transition operation of the PHY device 210 to the nominal transmission mode 610. In one implementation shown in FIG. 6, the absorption logic 160 may transition operation of the PHY device 210 from the accelerated transmission mode 630 to the nominal transmission mode 610 in response to the transition condition 642 occurring when the queue 146 is empty. In this example, no circumstances may exist for the absorption logic 160 to transition operation of the PHY device 210 from nominal transmission mode 610 to the accelerated transmission mode 630 because of the empty queue 146. In an alternative implementation, the PHY device 210 may operate in the nominal transmission mode 610 when the queue 146 is not empty. In this alternative implementation, the absorption logic 160 may also transition operation of the PHY device 210 from the accelerated transmission mode 630 or the throttled transmission mode 620 to the nominal transmission mode 610 in response to a transition condition occurring when a nominal control message is received from the switch 120. As another example, the absorption logic 160 may transition operation of the PHY device 210 from the accelerated transmission mode 630 to the nominal transmission mode 610 in response to a transition condition occurring when the amount of data in the queue 146 is below an empty threshold parameter, for example when the amount of data in the queue 146 is less than 1% of the capacity of the queue 146.

Concerning transitions to the accelerated transmission mode 630, the absorption logic 160 may transition operation of the PHY device 210 to the accelerated transmission mode 630 in response to various transition conditions, such as the transition condition 643 occurring when the absorption logic 160 receives an accelerate control message from the switch 120. In an alternative embodiment where the PHY device 210 may operate in the nominal transmission mode 210 even when the queue 146 is not empty, the absorption logic 160 may likewise transition operation of the PHY device 210 from the nominal transmission mode 610 to the accelerated transmission mode 630 when the absorption logic 160 receives an accelerate message. Also, the absorption logic 160 may transition operation of the PHY device 210 from the throttled transmission mode 620 to the accelerated transmission mode 630 in response to the transition condition 644 occurring when the amount of data in the queue 146 exceeds an overflow threshold (which may be identified through an overflow threshold parameter), such as 95% of the capacity of the queue 146. When the amount of data in the queue 146 exceeds the overflow threshold, the absorption logic 160 may also transmit an overflow control message to the switch, such as the overflow message 552.

In one implementation, burst absorption activity by any logic, module, or unit of the absorption logic 160, the PHY device 210, the switch 120, or the switch logic 520 may operate according to the Physical Coding Sublayer (PCS). That is, the PHY device 210 and the absorption logic 160 may provide burst absorption to the switch 120 without any additional MAC logic. Similarly, the switch 120 and the switch logic 520 may manage flow control of the PHY device 210 without any additional MAC logic as well. The flow control messages communicated between the PHY device 210 and the switch 120 may also be implemented according to the PCS, for example through reserved PCS encodings on the SerDes link. In this way, the exchange of flow control messages between the PHY device 210 and the switch 120 as well as burst absorption activities by the PHY device 210 and the switch 210 may be transparent to external devices on the network or higher layer processing on the network device that implements the PHY device 210 and the switch 120.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system comprising:
a queue operable to store incoming data received from a data port as queued data; and
absorption logic operable to:
support a nominal transmission mode by:
causing communication of the incoming data to a switch device at a nominal data rate expected by the switch;
support a throttled transmission mode by:
communicating pacing data interleaved with queued data to the switch device; and
support an accelerated transmission mode by:
causing communication of selected queued data from the queue to the switch device at the nominal data rate, and omitting unselected data among the queued data from the communication to the switch device.

2. The system of claim 1, where the absorption logic communicates the pacing data at a rate specified by an idle injection rate parameter.

3. The system of claim 2, further comprising:
an idle injection register operable to store the idle injection rate parameter.

4. The system of claim 1, where the absorption logic omits the unselected data when specified by an idle skip rate parameter.

5. The system of claim 4, further comprising:
an idle skip register operable to store the idle skip rate parameter.

6. The system of claim 1, where the absorption logic is further operable to control a transmission mode of the PHY layer device based on capacity of the queue.

7. The system of claim 1, where the absorption logic is further operable to control a transmission mode of the PHY layer device based on a control message received from the switch device.

8. A system comprising:
a port interface operable to receive data from a data port;
a switch interface operable to communicate with a switch device;
a queue communicatively coupled to the port interface and the switch interface; and
absorption logic operable to:
store the data received by the port interface in the queue; and
control transfer of the data from the PHY layer device to the switch device based on a transmission mode of the PHY layer device.

9. The system of claim 8, where the absorption logic is operable to control transfer of the data based on a transmission mode by:
when the PHY layer device operates in a nominal transmission mode:
transmitting the data at a nominal transmission rate;
when the PHY layer device operates in a throttled transmission mode:
transmitting the data at a reduced transmission rate slower than the nominal transmission rate;
when the PHY layer device operates in an accelerated transmission mode:
transmitting the data at an accelerated transmission rate faster than the nominal transmission rate by periodically skipping transmission of an idle word in the data.

10. The system of claim 8, where the absorption logic is further operable to:
transition the PHY layer device to operate in a nominal transmission mode when capacity of the queue is below an empty threshold parameter.

11. The system of claim 8, where the absorption logic is further operable to:
in response to receiving an accelerate message from the switch device:
transition the PHY layer device to operate in an accelerated transmission mode.

12. The system of claim 8, where the absorption logic is further operable to:
transition the PHY layer device to operate in an accelerated transmission mode when capacity of the queue exceeds an overflow threshold.

13. The system of claim 8, where the absorption logic is further operable to:
send an overflow message to the switch device when capacity of the queue exceeds an overflow threshold.

14. The system of claim 8, where the absorption logic is further operable to:
in response to receiving a throttle message from the switch device:
when the PHY layer device is operating in a nominal transmission mode:
transition the PHY layer device to operate in a throttled transmission mode; and
when the PHY layer device is operating in an accelerated transmission mode:
transition the PHY layer device to operate in a throttled transmission mode if capacity of the queue is below an overflow threshold.

15. A system comprising:
in a PHY layer device:
a queue operable to buffer data; and
absorption logic operable to:
transmit a data stream from the queue to a switch device at a nominal transmission rate, with data stream content of the data stream responsive to capacity of the queue, a control message received from the switch device, or both.

16. The system of claim 15, where the absorption logic is further operable to communicate with the switch device through serializer/deserializer (SerDes) encoded data.

17. The system of claim 16, where the control message comprises a Physical Coding Sublayer (PCS) SerDes encoding.

18. The system of claim 17, where the control message is encoded according to 8b/10b SerDes encoding technique.

19. The system of claim 17, where the control message is encoded according to 64b/66b SerDes encoding technique.

20. The system of claim 16, where the absorption logic is operable to send an overflow message to the switch device when capacity of the queue exceeds an overflow threshold, where the overflow message comprises a SerDes encoded symbol and is encoded according to an 8b/10b SerDes encoding technique or a 64b/66b SerDes encoding technique.
